(19) United States
(12) Patent Application Publication
(10) Pub. No.: US 2017/0190195 A1
(43) Pub. Date: Jul. 6, 2017

(54) TAPE CARTRIDGE

(71) Applicant: Seiko Epson Corporation, Tokyo (JP)

(72) Inventors: Shinsaku KOSUGE, Suwa-shi (JP); Yasumasa NAKAJIMA, Suwa-shi (JP)

(21) Appl. No.: 15/510,672

(22) PCT Filed: Jul. 31, 2015
(86) PCT No.: PCT/JP2015/071888

§ 371 Date: Mar. 10, 2017

(30) Foreign Application Priority Data
Sep. 30, 2014 (JP) 2014-200444

(51) Int. Cl. B41J 32/00; B41J 3/407

(52) U.S. Cl. CPC B41J 32/00; B41J 3/4075

(57) ABSTRACT

A tape cartridge detachably mounted to a cartridge mounting section of a tape printer includes a cartridge casing that has a first casing on a front side in a mounting direction in which the tape cartridge is mounted to the cartridge mounting section, and a second casing on a rear side with respect to the front side in the mounting direction, a tape roll that is accommodated in the cartridge casing and in which a print tape is wound around a spool, and a rotating guide section that is provided in the second casing and guides the rotation of the tape roll in sliding contact with an inner circumferential surface of the spool.

### CROSS-REFERENCE TO RELATED APPLICATIONS

This application is the U.S. National Phase under 35 U.S.C. §371 of International Application No. PCT/JP2015/071888 filed on Jul. 31, 2015, which in turn claims the benefit of Japanese Application No. 2014-200444 filed on Sep. 30, 2014, the disclosures of which are expressly incorporated by reference herein.

### TECHNICAL FIELD

The present invention relates to a tape cartridge of two division structures in which a tape roll formed by winding a print tape around a spool is accommodated.

### BACKGROUND ART

In the related art, as this kind of the tape cartridge, (see JP-2012-006295), a tape cartridge which stores a tape body formed by winding a print tape around a spool has been known. An outer shell of the tape cartridge is formed by a cartridge casing including an upper casing and a lower casing. The cartridge casing stores a tape body in which the print tape is wound around the spool, a ribbon body in which an ink ribbon is wound around a ribbon core, a winding core around which the ink ribbon is wound, and a platen roller which feeds the print tape and the ink ribbon.

The spool is integrally formed by a tape core in which the print tape is wound, and an annular rib protruding from an inner circumferential surface of the tape core. On the other hand, in the lower casing, a pivoting support section inserted into a shaft hole formed in an axial center of the rib to rotatably and pivotally support the spool (tape body), and a rotating guide section attached to the pivoting support section and being sliding contact with the inner circumferential surface of the tape core are integrally formed. Further, the inclination of the spool is suppressed by the rotating guide section, so that the rotation of the spool (tape body) pivotally supported by the pivoting support section can be stabilized.

### SUMMARY

In such a conventional tape cartridge, it is possible to stabilize the rotation of the spool (tape body) by the pivoting support section and the rotating guide section. However, since the pivoting support section and the rotating guide section are provided in the lower casing, there is a problem of complication of work occurs in the assembling of the tape cartridge. Specifically, upon assembly of the tape cartridge, it is necessary to align the feeding end of the print tape fed out from the tape body to the tape guide, the platen roller and the tape outlet making up the tape sending path. At the same time, it is necessary to insert the tape body into the lower casing, while aligning the tape core and the rib of the spool with the pivoting support section and rotating guide section. That is, it is necessary to perform the alignment of the feeding end of the print tape, and the alignment of the spool at the same time. Therefore, there was a problem of complication of the assembling of the tape cartridge.

An object of the present invention is to provide a tape cartridge which is capable of stabilizing the rotation of the tape roll, and smoothly performing the assembling.

### Solution to Problem

According to the present invention, there is provided a tape cartridge for being detachably mounted to a cartridge mounting section of a tape printer, the tape cartridge including: a cartridge casing that has a first casing on a front side in a mounting direction in which the tape cartridge is mounted to the cartridge mounting section, and a second casing on a rear side with respect to the front side in the mounting direction; a tape roll that is accommodated in the cartridge casing and in which the print tape is wound around the spool; and a rotating guide section that is provided in the second casing and guides the rotation of the tape roll in sliding contact with an inner circumferential surface of the spool.

According to this configuration, because the cartridge casing is provided with a rotating guide section which guides the rotation of the tape roll, it is possible to stabilize the rotation of the tape roll. Also, because the rotating guide section is configured to be provided in the second casing on the rear side in the mounting direction, when the tape roll is incorporated into the first casing on the front side in the mounting direction, the feeding end of the print tape may be aligned in the sending path, and the alignment between the spool and the rotating guide section of the second casing may be performed when joining the second casing to the first casing. That is, since the alignment between the feeding end of the print tape and the sending path, and the alignment between the spool and the rotating guide section may be performed as separate operations, it is possible to smoothly perform the assembling.

In this case, it is preferred that the second casing and the rotating guide section are integrally formed.

According to this configuration, it is possible to easily form the rotating guide section, and it is possible to reduce the number of parts and assembly man-hours as a whole.

Further, it is preferred that the rotating guide section is formed into a cylindrical shape, and comes into sliding contact with the entire circumference of the inner circumferential surface of the spool.

According to this configuration, it is possible to further stabilize the rotation of the tape roll.

Similarly, it is preferred that the rotating guide section has at least one sliding-contact piece that is disposed in a circumferential direction.

According to this configuration, in the assembling operation, it is possible to easily perform the alignment between the spool and the rotating guide section, thereby improving the assembling property.

In this case, it is preferred that the one sliding-contact piece is disposed on a normal line of a position at which the print tape is fed and a winding state is released.

According to this configuration, upon feeding of the print tape, since the one sliding-contact piece 1 is provide in a site on which a strong force acts in a tangential direction, it is possible to stabilize the rotation of the tape roll with a simple structure.

Meanwhile, it is preferred that the spool includes: a tape core around which the print tape is wound; and an annular rib which is provided in an inner circumferential surface of the tape core and in an axially intermediate portion of the inner circumferential surface of the tape core, and has a shaft hole being formed in a shaft center of the tape core, and the tape cartridge further includes a spool pivoting support section which extends from the rotating guide section, and is inserted into the shaft hole to rotatably and pivotally support the spool.

According to this configuration, the spool is rotatably pivotally supported by the core pivoting support section, and the inclination of the spool can be suppressed by the rotating guide section at the time of rotation. Accordingly, the spool (tape roll) rotates without rattling, and it is possible to further stabilize the rotation of the tape roll.

In this case, it is preferred that the rib includes a ratchet which is provided on a surface of the second casing, and the tape cartridge further includes a coil spring which is disposed inside the rotating guide section and inside the core pivoting support section, and receives the second casing and brings a wire end into contact with the ratchet to restrict rotation of the spool.

According to this configuration, since the rotation of the spool is restricted by the coil spring, it is possible to prevent problems such as feeding end of the print tape drawn into the cartridge casing due to vibration or the like.

### BRIEF DESCRIPTION OF THE DRAWINGS

FIG. 1 is an external perspective view of an open lid state of a tape printer.

FIG. 2 is a plan view illustrating an upper casing of a tape cartridge according to a first embodiment in a broken line.

FIG. 3 is a perspective view of a cartridge mounting section.

FIG. 4 is an exploded perspective view of the tape cartridge according to the first embodiment.

FIG. 5 is a perspective view of the upper casing of the tape cartridge according to the first embodiment.

FIG. 6A is a cross-sectional view of a non-mounted state of the tape cartridge according to the first embodiment with respect to the cartridge mounting section, and FIG. 6B is a cross-sectional view of a mounted state.

FIG. 7 is a perspective view of an upper casing of a tape cartridge according to a second embodiment.

FIG. 8 is a cross-sectional view of a non-mounted state of the tape cartridge according to the second embodiment with respect to the cartridge mounting section.

FIG. 9 is a perspective view of an upper casing of a tape cartridge according to a third embodiment.

FIG. 10 is a perspective view of an upper casing of a tape cartridge according to a fourth embodiment.

FIG. 11A is a cross-sectional view of a non-mounted state of the tape cartridge according to the fourth embodiment with respect to the cartridge mounting section, and FIG. 11B is a cross-sectional view of a mounted state.

### DESCRIPTION OF EXEMPLARY EMBODIMENTS

Hereinafter, a tape cartridge according to an embodiment of the present invention will be described in conjunction with a tape printer on which the tape cartridge is mounted with reference to the accompanying drawings. The tape printer performs printing, while feeding the print tape and the ink ribbon from the mounted tape cartridge, and creates a label (tape piece) by cutting the printed portion of the print tape.

[Outline of Tape Printer]

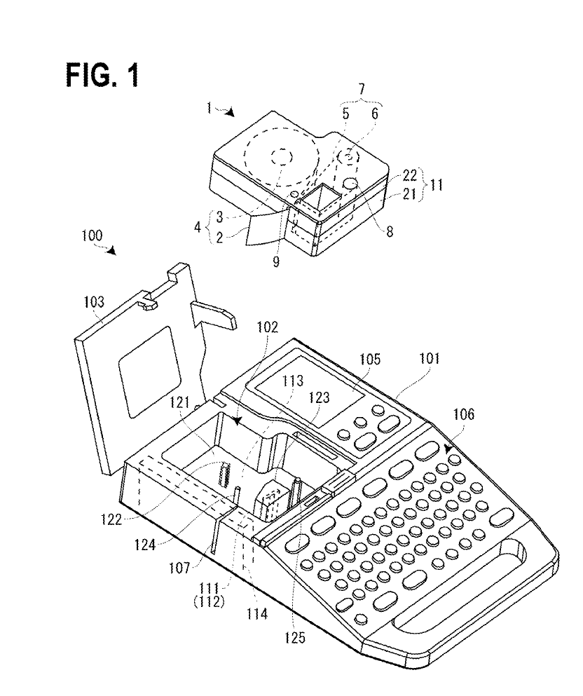

FIG. 1 is an external perspective view of the open lid state of a tape printer 100. As illustrated in FIG. 1, the tape printer 100 includes an apparatus casing 101 constituting an outer shell, a cartridge mounting section 102 on which the tape cartridge 1 is detachably mounted, and an opening and closing lid 103 for opening and closing the cartridge mounting section 102. On the upper surface of the apparatus casing 101, the cartridge mounting section 102 is provided in the left portion of the rear side, a display 105 is provided in the right portion of the rear side, and a keyboard 106 is further provided on the front side. On the other hand, on the side surface (left side surface) of the apparatus casing 101, an elongated tape discharging port 107 from which the print tape 2 is discharged is provided.

Further, the tape printer 100 includes a printing mechanism 112 having a print head 111 erected on the cartridge mounting section 102, a tape feeding mechanism 113 built in the back space of the cartridge mounting section 102, and a tape cutting mechanism 114 built in the vicinity of the tape discharge port 107a. The cartridge mounting section 102 is recessed so as to form a complementary shape to the tape cartridge 1.

A user inputs the print information using the keyboard 106, and after checking the print information on the display 105, commands printing by the key operation. When printing is commanded, the tape feeding mechanism 113 is driven to cause the print tape 2 and the ink ribbon 5 to run in parallel, and printing of the thermal transfer is performed thereon in the printing mechanism 112. By the printing feeding, the print tape 2 is discharged from the tape discharging port 107, and when printing is completed, the tape cutting mechanism 114 is driven, and the printed portion of the print tape 2 is cut off.

[Outline of Tape Cartridge]

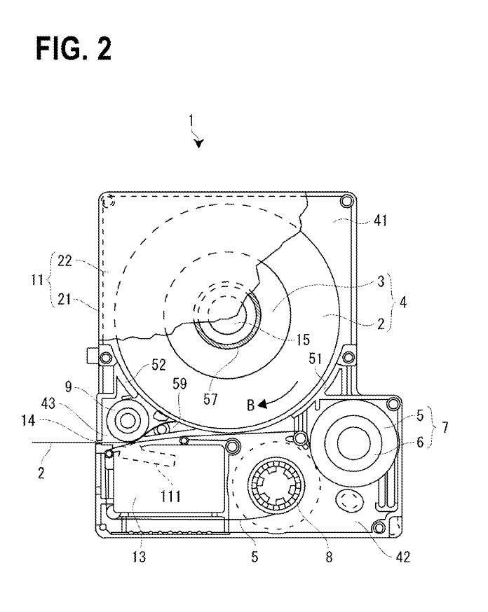

As illustrated in FIGS. 1 and 2, the tape cartridge 1 includes a tape roll 4 in which the print tape 2 is wound around the spool 3, and a ribbon roll 7 in which the ink ribbon 5 is wound around a feeding core 6. The tape cartridge 1 includes a take-up core 8 which takes up the ink ribbon 5 after use, and a platen roller 9 against which the print head 111 abuts via the ink ribbon 5 and the print tape 2 to send the print tape 2 and the ink ribbon 5. Further, the tape cartridge 1 is provided with a cartridge casing 11 that stores the tape roll 4, the ribbon roll 7, the take-up core 8 and the platen roller 9. In this way, the tape cartridge 1 of this embodiment has a so-called shell structure in which the outer shell is covered with the cartridge casing 11.

In the cartridge casing 11, an insertion opening 13 into which the print head 111 is inserted when mounted is formed. Further, on the side surface of the cartridge casing 11, a tape outlet 14 from which the print tape 2 is sent out is formed. Further, on the back surface of the cartridge casing 11, a core recess 15 which is positioned on a base protrusion 122 to be described later when mounted is formed.

By the aforementioned tape feeding mechanism 113, when the platen roller 9 and the take-up core 8 are driven, the print tape 2 is fed out from the spool 3, and the ink ribbon 5 is fed from the feeding core 6. The fed print tape 2 and the ink ribbon 5 run in parallel in the portion of the platen roller 9 and are provided to printing by the print head 111. The feeding end (printed portion) of the print tape 2 subjected to printing is sent toward the tape discharging port 107 from the tape outlet 14. On the other hand, the ink ribbon 5 turns around the circumferential wall of the insertion opening 13, and is wound around the take-up core 8. As the tape cartridge 1, tape cartridges of plural kinds having different thicknesses are prepared depending on the tape width of the print tape 2.

[Relation Between Tape Printer and Tape Cartridge]

As illustrated in FIG. 1, in the mounting base 121 of the cartridge mounting section 102, a base protrusion 122 loosely fitted to the core recess 15 (see FIG. 2) of the tape cartridge 1 when the tape cartridge 1 is mounted, the print head 111 covered with a head cover 123, a platen drive shaft 124 for rotationally driving the platen roller 9, and a take-up driving shaft 125 for rotationally driving the take-up core 8 are erected. Further, the tape feeding mechanism 113 having a motor and gear train (both are not illustrated) for rotating the platen drive shaft 124 and the take-up driving shaft 125 are built in the rear space of the mounting base 121.

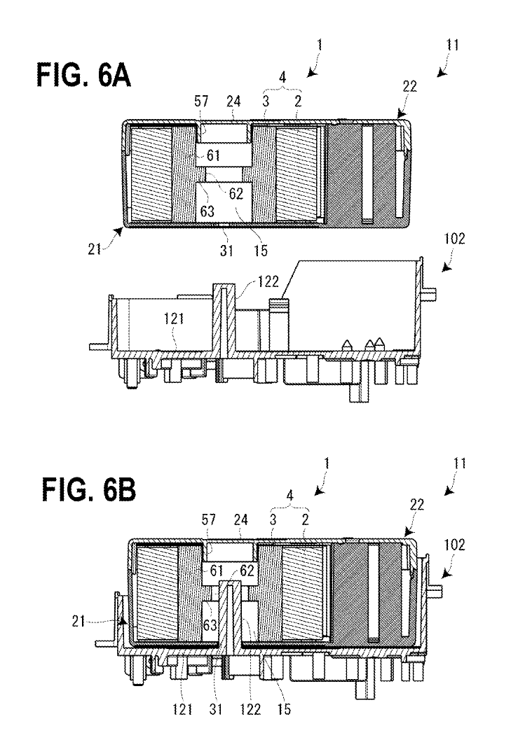

When the tape cartridge 1 is mounted on the cartridge mounting section 102, the core recess 15 is engaged with the base protrusion 122 (see FIGS. 6A and 6B), the platen roller 9 is engaged with the platen drive shaft 124, and the take-up core 8 is engaged with the take-up driving shaft 125. When closing the lid 103, the print head 111 rotates to come into contact with the platen roller 9 across the print tape 2 and the ink ribbon 5, and the tape printer 100 is in a printing standby state.

[Details of Tape Cartridge]

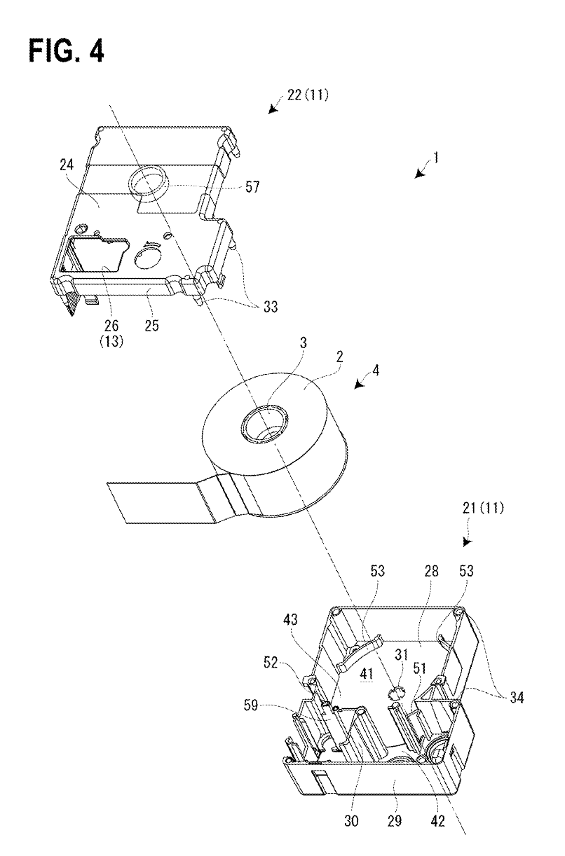

The tape cartridge 1 will be described in detail referring to FIGS. 2 and 4. As described above, the tape cartridge 1 includes a cartridge casing 11, and a tape roll 4, a ribbon roll 7, a take-up core 8 and a platen roller 9 stored therein. The cartridge casing 11 constitutes an outer shell of the tape cartridge 1 (shell structure), and has an “L” shape appearance in a plan view in which the right proximal end side slightly protrudes.

The cartridge casing 11 in the front and back direction, has a lower casing 21 (first casing) serving as rear side when mounted to the cartridge mounting section 102, and an upper casing 22 (a second casing) serving as a front side (see FIG. 4). The cartridge casing 11 of the embodiment, the upper casing 22 is constituted by a transparent resin molded article, and the lower casing 21 is constituted by an opaque resin molded article.

The upper casing 22 is integrally formed (molded) by a top wall 24 forming the surface of the cartridge casing 11, and an upper circumferential wall 25 vertically provided on the circumference of the top wall 24. The top wall 24 is formed with a rectangular opening 26 which constitutes a part of the insertion opening 13 (see FIG. 4).

The lower casing 21 is integrally formed (molded) by a bottom wall 28 which constitutes the back surface of the cartridge casing 11, a lower circumferential wall 29 erected on the circumference of the bottom wall 28, and an opening circumferential wall 30 erected on the bottom wall 28 to define the insertion opening 13. The bottom wall 28 is formed with a fitting opening 31 which constitutes a part of the core recess 15 (see FIG. 4). Further, the upper casing 22 and the lower casing 21 are press-fitted and joined by pins 33 and through holes 34 formed on joining end surfaces (the upper circumferential wall 25 and the lower circumferential wall 29) (can be disassembled and reused).

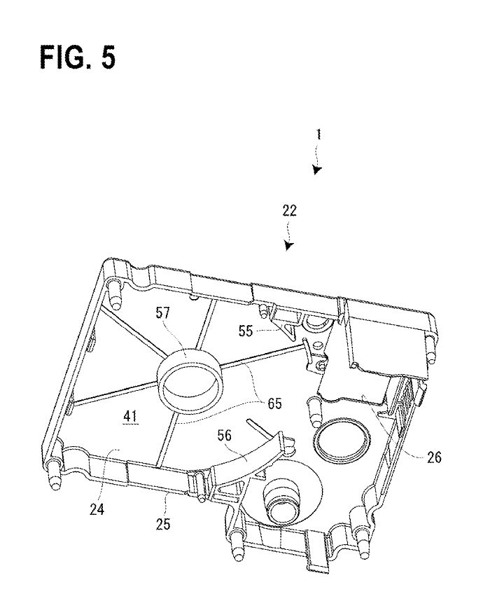

As illustrated in FIGS. 2 and 5, at a distal end side of the cartridge casing 11, a wide tape storage section 41 is formed. The tape storage section 41 rotatably stores the tape roll 4. Further, a ribbon storage section 42 adjacent to the insertion opening 13 is formed on the base right side of the cartridge casing 11. In the ribbon storage section 42, a ribbon roll 7 (feeding core 6) is rotatably stored on the right side, and a take-up core 8 is rotatably stored on the left side, respectively. Further, on the base left side in the cartridge casing 11, the platen storage section 43 adjacent to the insertion opening 13 is formed. Further, the platen roller 9 is rotatably stored in the platen storage section 43.

As illustrated in FIGS. 4 and 5, the lower casing 21 is formed with a first lower partition wall 51 which defines the tape storage section 41 and the ribbon storage section 42, a second lower partition wall 52 which defines the tape storage section 41 and the platen storage section 43, and a pair of third left and right lower partition walls 53 provided on the distal end side of the tape storage section 41. Each of the first lower partition wall 51, the second lower partition wall 52 and the pair of third lower partition walls 53 is formed in an arc shape, and is arranged along the outer circumference of the tape roll 4. Further, in the center of the tape storage section 41 in the lower casing 21, the fitting opening 31 is formed (details thereof will be described later).

Similarly, the upper casing 22 is formed with a first upper partition wall 55 which defines the tape storage section 41 and the ribbon storage section 42, a second upper partition wall 56 which defines the tape storage section 41 and the platen storage section 43. In this case, each of the first upper partition wall 55 and the second upper partition wall 56 is formed in an arc shape, and is arranged along the outer circumference of the tape roll 4. Further, in the center of the tape storage section 41 of the upper casing 22, a rotating guide section 57 for guiding the rotation of the tape roll 4 is formed (the details thereof will be described later).

On the other hand, as illustrated in FIGS. 2 and 4, in the lower casing 21 located near the platen roller 9, a tape guide 59 which guides the fed print tape 2 to the platen roller 9 is erected. That is, in the interior of the cartridge casing 11, a sending path of the print tape 2 leading to the tape outlet 14 via the tape guide 59 and the platen roller 9 based on the tape roll 4 as a starting point is formed. The outer circumference of the tape roll 4 facing the tape guide 59 is a site in which the print tape 2 is fed from the tape roll 4 to release its wound state (the details thereof will be described later).

[First Embodiment of Tape Cartridge]

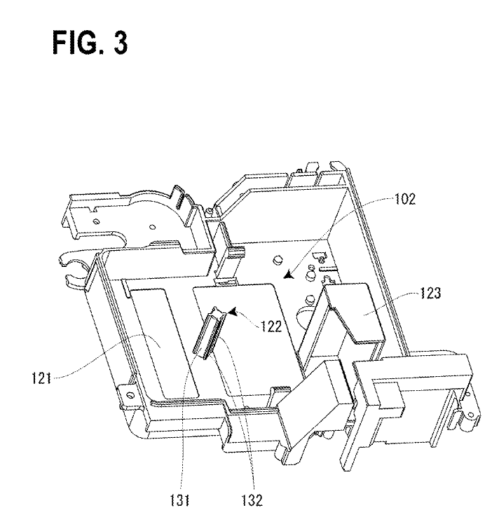

Next, the tape cartridge 1 according to the first embodiment will be described with reference to FIGS. 3 to 6B.

As described above, a core recess 15 is formed on the back surface of the tape cartridge 1, and the base protrusion 122 is formed in the cartridge mounting section 102, correspondingly. The base protrusion 122 is formed integrally with a cylindrical protrusion main body 131, and four protrusions 132 protruding at the four locations in the circumferential direction of the protrusion main body 131. The base protrusion 122 is integrally formed with the mounting base 121 (see FIG. 3).

On the other hand, the core recess 15 is continuous to the cartridge casing 11 to include a fitting opening 31 formed in the bottom wall 28 of the lower casing 21. The fitting opening 31 constituting the base of the core recess 15 is fitted to the base protrusion 122 of the cartridge mounting section 102. Therefore, the fitting opening 31 is formed in a complementary shape to the cross-sectional shape of the base protrusion 122 (see FIG. 4). When mounting the tape cartridge 1 into the cartridge mounting section 102, the fitting opening 31 is fitted to the base protrusion 122, and the tape cartridge 1 is positioned in the cartridge mounting section 102 (see FIG. 6B).

Further, the rear side of the core recess 15 is a space defined by the inner circumferential surface of the spool 3 and the inner surface of the upper casing 22, and the rotating guide section 57 for guiding the rotation of the spool 3 faces the space so as to be suspended down from the upper casing 22, (see FIG. 6A).

The spool 3 has a tape core 61 around which the print tape 2 is wound, and an annular rib 63 (rib) which is provided in the axially intermediate portion of the inner circumferential surface of the tape core 61, and has a shaft hole 62 formed in the shaft center. The space of the core recess 15 is defined by the inside of the tape core 61 and the inside of the annular rib 63 (the shaft hole 62).

As mentioned above, the rotating guide section 57 is located at the center of the tape storage section 41 of the upper casing 22, and is formed integrally with the upper casing 22 (the top wall 24). The rotating guide section 57 is formed in a cylindrical shape, and protrudes to be short from the inner surface of the top wall 24. Further, on the inner surface of the top wall 24, a plurality of rib segments 65 extending radially from the position of the rotating guide section 57 are formed. In this way, the rotating guide section 57 and the plurality of rib segments 65 formed on the inner surface of the top wall 24 function as a reinforcing rib of the top wall 24.

The outer diameter of the rotating guide section 57 and the inner diameter of the tape core 61 are formed substantially in the same diameter, and the rotating guide section 57 comes into sliding contact with the upper inner circumferential surface of the tape core 61 on its outer circumferential surface to guide the rotation of the spool 3 (tape roll 4). When the print tape 2 is fed from the tape roll 4, the tape roll 4 (the spool 3) rotates. Accordingly, the rotating guide section 57 for guiding the rotation of the tape roll 4 substantially pivotally supports the tape roll 4 (the spool 3) in a rotatable manner.

In this way, according to the first embodiment, since the rotating guide section 57 is provided in the upper casing 22 (top wall 24), with the feeding of the print tape 2, the tape roll 4 rotates in the cartridge casing 11 without rattling. Accordingly, it is possible to stabilize the rotation of the tape roll 4.

Incidentally, in the assembly of the tape cartridge 1, after setting the components such as the tape roll 4 and the ribbon roll 7 to the lower casing 21, the upper casing 22 is joined to the lower casing 21. On the other hand, the tape roll 4 of the assembled state enters a state in which the print tape 2 fed as described above is aligned with the tape guide 59, the platen roller 9 and the tape outlet 14 as the sending path, and the spool 3 is aligned with the rotating guide section 57.

According to the first embodiment, since the rotating guide section 57 is provided in the upper casing 22, when the tape roll 4 is incorporated into the lower casing 21, the feeding end of the print tape 2 may be aligned with the sending path, and the alignment between the spool 3 and the rotating guide section 57 may be performed when joining the upper casing 22 to the lower casing 21. That is, the alignment between the feeding end of the print tape 2 and sending path, and the alignment between the spool 3 and the rotating guide section 57 may be performed as separate operations. Accordingly, it is possible to smoothly perform the assembly of the tape cartridge 1.

[Second Embodiment of Tape Cartridge]

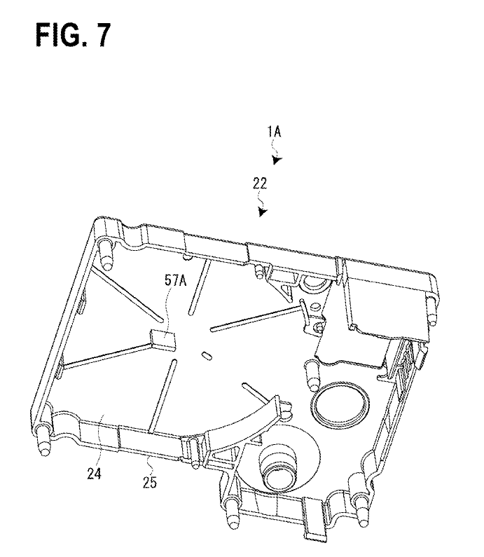

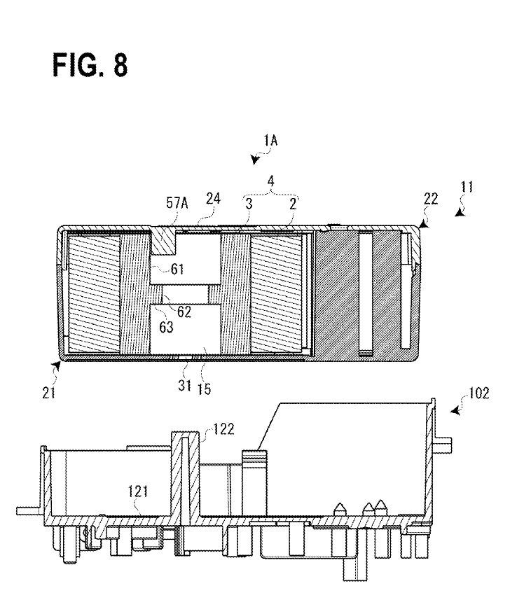

Next, a tape cartridge 1A according to a second embodiment will be described with reference to FIGS. 7 and 8. In the second embodiment, differences from the first embodiment will be mainly described.

In the tape cartridge 1A, the rotating guide section 57 is made up of guide piece 57A (sliding-contact piece) which extending in the radial direction. Even in this case, the guide piece 57A is formed integrally with the upper casing 22 (the top wall 24). Further, the guide piece 57A is formed in a thick plate shape, and protrudes to be short from the inner surface of the top wall 24. One of the outer end surfaces of the guide piece 57A comes into sliding contact with the upper inner circumferential surface of the tape core 61 to guide the rotation of the spool 3 (the tape roll 4).

In this second embodiment, the rotation of the tape roll 4 can be stabilized by the guide piece 57A. Further, since the guide piece 57A is provided on the upper casing 22, the assembly of the tape cartridge 1A can be more smoothly performed. The guide piece 57A is preferably disposed on the normal line of a position at which the print tape 2 is fed from the tape roll 4 to release the wound state.

[Third Embodiment of Tape Cartridge]

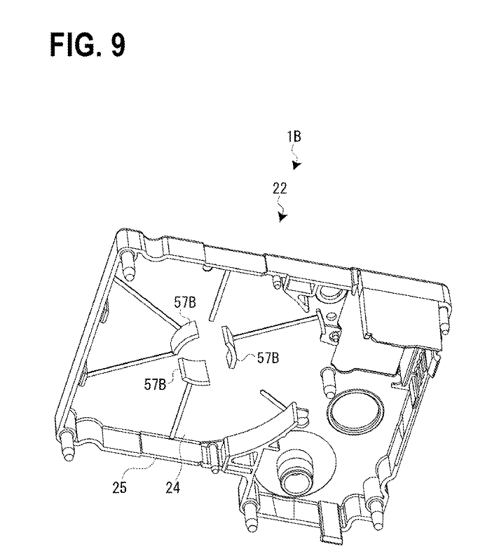

Next, a tape cartridge 1B according to a third embodiment will be described with reference to FIG. 9. In the third embodiment, differences from the first embodiment will be mainly described.

In the tape cartridge 1B, the rotating guide section 57 is made up of three arc-shaped guide pieces 57B (sliding-contact pieces). The three arc-shaped guide pieces 57B have a form in which three positions in the circumferential direction of the rotating guide section 57 of the first embodiment are removed, and the three arc-shaped guide pieces 57B are circumferentially evenly arranged. In this case, the three arc-shaped guide pieces 57B are formed integrally with the upper casing 22 (the top wall 24). Each arc-shaped guide piece 57B is formed in an arc shape, and protrudes to be short from the inner surface of the top wall 24. The three arc-shaped guide pieces 57B come into sliding contact with the upper inner circumferential surface of the tape core 61 at each of the outer circumferential surfaces to guide (rotatably and pivotally support) the rotation of the spool 3 (tape roll 4).

In the third embodiment, the rotation of the tape roll 4 can be stabilized by the three arc-shaped guide pieces 57B. Further, since the three arc-shaped guide pieces 57B are provided on the upper casing 22, it is possible to smoothly perform the assembly of the tape cartridge 1B. Among the three arc-shaped guide pieces 57B, any one arc-shaped guide piece 57B is preferably disposed on the normal line of the position at which the print tape 2 is fed from the tape roll 4 to release the wound state.

[Fourth Embodiment of Tape Cartridge]

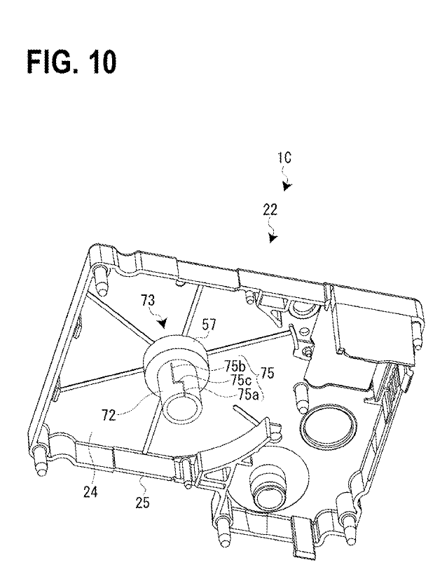

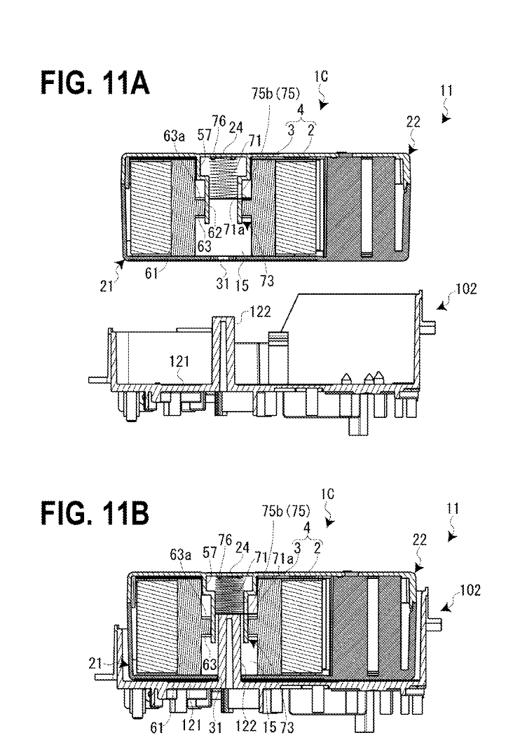

Next, a tape cartridge 1C according to a fourth embodiment will be described with reference to FIGS. 10 to 11B. In the fourth embodiment, differences from the first embodiment will be mainly described.

In the tape cartridge 1C, a reverse rotation preventing mechanism for preventing the reverse rotation of the tape roll 4 is constituted by a coil spring 71 which is incorporated by using the rotating guide section 57.

The upper casing 22 is provided with a stepped shaft 73 that includes a rotating guide section 57, and a core pivoting support section 72 extending from the distal end of the rotating guide section 57. In this case, the rotating guide section 57 comes into sliding contact with the upper inner circumferential surface of the tape core 61 to guide (rotatably and pivotally support) the rotation of the spool 3 at its outer circumferential surface, and while, the core pivoting support section 72 rotatably and pivotally supports the spool 3 (the annular rib 63) that is inserted into the shaft hole 62 on the outer circumferential surface thereof.

Further, the core pivoting support section 72 is formed with a crank-shaped slit 75 for setting the above-described coil spring 71. The slit 75 has a lower slit 75a and an upper slit 75b extending in the axial direction, and a horizontal slit 75c through which the upper end of the lower slit 75a and the lower end of the upper slit 75b communicate with each other.

The coil spring 71 functioning as a compression spring is incorporated into the stepped shaft 73. A lower wire end 71a of the coil spring 71 extends outward in the radial direction. Therefore, when setting the coil spring 71, the coil spring 71 is inserted into the stepped shaft 73 from the lower side, the wire end 71a is moved to the horizontal slit 75c from the lower slit 75a so as to be located at the lower end of the upper slit 75b. The lower end of the coil spring 71 is positioned on the inner circumferential surface of the core pivoting support section 72, the upper end thereof is positioned on the outer circumferential surface of the annular protrusion 76 formed on the upper casing 22.

On the other hand, a ratchet 63a is formed on the surface of the annular rib 63 of the spool 3 (which is also formed on the back surface). The ratchet 63a is a so-called face ratchet having a plurality of radial ratchet grooves, and a wire end 71a of the coil spring 71 protruding from the slit 75 is engaged with the ratchet groove (see FIG. 11A).

As illustrated in FIG. 11A, when joining the lower casing 21 to the upper casing 22 incorporated with the coil spring 71, the wire end 71a of the coil spring 71 engages with the ratchet 63a, and at the same time, the coil spring 71 is slightly compressed. That is, the wire end 71a of the coil spring 71 enters a state of being pressed against the ratchet 63a. In this state, the rotation of the spool 3 is restricted via the annular rib 63 by the coil spring 71. This prevents the reverse rotation of the tape roll 4, which makes it possible to prevent the feeding end of the print tape 2 from being drawn into the cartridge casing 11 from the tape outlet 14 at the time of transportation or the like.

On the other hand, as illustrated in FIG. 11B, when mounting the above-described tape cartridge 1C on the cartridge mounting section 102, the coil spring 71 is pushed up by the base protrusion 122 that relatively engages with the core recess 15. Thus, the wire end 71a of the coil spring 71 is disengaged from the ratchet 63a, and the rotation restriction of the spool 3 is released. That is, it is possible to send (feed) the print tape 2.

According to the fourth embodiment, because the spool 3 is pivoted at two locations of the core pivoting support section 72 and the rotating guide section 57, it is possible to further stabilize the rotation of the tape roll 4. Further, since the stepped shaft 73 is provided on the upper casing 22, it is possible to smoothly perform the assembly of the tape cartridge 1C. Furthermore, it is possible to prevent the reverse rotation of the tape roll 4 by the reverse rotation preventing mechanism, which makes it possible to effectively prevent the feeding end of the print tape 2 from being drawn into the cartridge casing 11.

1. A tape cartridge detachably mounted to a cartridge mounting section of a tape printer, the tape cartridge comprising:
a cartridge casing that has a first casing on a front side in a mounting direction in which the tape cartridge is mounted to the cartridge mounting section, and a second casing on a rear side with respect to the front side in the mounting direction;
a tape roll that is accommodated in the cartridge casing and in which the print tape is wound around the spool; and
a rotating guide section that is provided in the second casing and guides the rotation of the tape roll in sliding contact with an inner circumferential surface of the spool.

2. The tape cartridge according to claim 1, wherein the second casing and the rotating guide section are integrally formed.

3. The tape cartridge according to claim 1, wherein the rotating guide section is formed into a cylindrical shape, and comes into sliding contact with the entire circumference of the inner circumferential surface of the spool.

4. The tape cartridge according to claim 1, wherein the rotating guide section has at least one sliding-contact piece that is disposed in a circumferential direction around the spool.

5. The tape cartridge according to claim 4, wherein the one sliding-contact piece is disposed on a normal line of a position at which the print tape is fed and a winding state is released.

6. The tape cartridge according to claim 1, wherein the spool includes:
a tape core around which the print tape is wound; and
an annular rib which is provided in an inner circumferential surface of the tape core and in an axially intermediate portion of the inner circumferential surface of the tape core, and includes a shaft hole being formed in a shaft center of the tape core, and
the tape cartridge further includes a spool pivoting support section which extends from the rotating guide section, and is inserted into the shaft hole to rotatably and pivotally support the spool.

7. The tape cartridge according to claim 6, wherein the rib includes a ratchet that is provided on a surface of the second casing, and
the tape cartridge further includes a coil spring which is disposed inside the rotating guide section and inside the core pivoting support section, and receives the second casing and brings a wire end into contact with the ratchet to restrict rotation of the spool.
